(19) United States
(12) Patent Application Publication
(10) Pub. No.: US 2016/0313493 A1
(43) Pub. Date: Oct. 27, 2016

(54) LIGHT GUIDE PLATE AND TRANSPARENT DISPLAY APPARATUS HAVING THE SAME

(71) Applicant: CHI LIN OPTOELECTRONICS CO., LTD., Tainan City (TW)

(72) Inventors: KUN-HSIEN LEE, TAINAN CITY (TW); MING-HSIEN WU, TAINAN CITY (TW); YI-HSUAN TAI, TAINAN CITY (TW); CHIN-MING WANG, TAINAN CITY (TW); HUNG-WEN WANG, TAINAN CITY (TW); HUANG-CHIEH CHIU, TAINAN CITY (TW)

(21) Appl. No.: 14/697,287

(22) Filed: Apr. 27, 2015

(51) Int. Cl. F21V 8/00

(52) U.S. Cl. CPC G02B 6/0036; G02B 6/0073; G02B 6/0068

(57) ABSTRACT

The present disclosure relates to a light guide plate and a display apparatus having the same. The light guide plate includes a transparent light guide plate body and a plurality of microstructures. The transparent light guide plate body has a first surface and a second surface opposite to the first surface, wherein the first surface has a surface roughness of less than or equal to 100 nm. The microstructures are disposed on the first surface. A light beam from the transparent light guide plate body is reflected by the microstructures, and another light beam from the transparent light guide plate body passes through the first surface between the microstructures.

### BACKGROUND

1. Technical Field

The present disclosure relates to a light guide plate and a display apparatus having the same, and more particularly to a light guide plate having a plurality of microstructures, and a transparent display apparatus having the same.

2. Description of the Related Art

FIG. 1 shows a schematic cross-sectional view of a conventional display apparatus. The conventional display apparatus 1 comprises a light source 11, a reflector 12, a light guide plate 14, one or more optical films 16, and a panel 17. The light guide plate 14 is used to receive and mix the light beam from the light source 11, and has a top surface (light-emitting surface) 141, a bottom surface 142 and a side surface (light incident surface) 143. The top surface 141 is opposite to the bottom surface 142, and the side surface 143 extends between the top surface 141 and the bottom surface 142. The light source 11, for example, a light emitting diodes (LED) light bar or a CCFL, is disposed adjacent to the side surface 143 of the light guide plate 14, and is used to provide a light beam. Thus, the light beam enters the light guide plate 14 through the side surface 143 and then is transmitted to the optical films 16 through the top surface 141. The optical films 16 are disposed above/adjacent to the top surface 141 of the light guide plate 14. The optical films 16 may be a diffusion film, a brightness enhancement film and so on. The reflector 12 is disposed below/adjacent to the bottom surface 142 of the light guide plate 14, and is used to reflect part of the light beam back to the light guide plate 14. The panel 17 is disposed above/adjacent to the optical films 16, and is used to show an image.

The disadvantages of the conventional display apparatus 1 are described as follows. First, because the elements of the conventional display apparatus 1, e.g., the reflector 12, the light guide plate 14, the optical films 16 and the panel 17 are usually not transparent, the conventional display apparatus 1 is opaque when the light source 11 is turned off. Thus, the users cannot see through the conventional display apparatus 1. Second, the distance D1 between the panel 17 and the light guide plate 14 is relatively large (greater than 10 mm), thus, the total thickness of the conventional display apparatus 1 cannot be reduced efficiently.

FIG. 2 shows a schematic perspective view of the light guide plate of FIG. 1. The point A is at any position on the top surface 141 of the light guide plate 14. The luminance of a first output light L1 from the point A along a Z1 direction is defined as I₁, wherein the Z1 direction is perpendicular to the top surface 141 of the light guide plate 14. The luminance of a second output light L2 from the point A along a Z2 direction is defined as I₂, wherein the inclination angle between the Z1 direction and the Z2 direction is 45 degrees. The ratio of I₁ to I₂ is less than 1, usually is about 0.25. Thus, the luminance I₁ of the first output light L1 is less than the luminance I₂ of the second output light L2, and the differences between the luminance of the different output lights from the same point along different directions are relatively large. As a result, when a user watches an image shown on the conventional display apparatus 1, he needs to watch the conventional display apparatus 1 along a direction substantially parallel to the Z2 direction since the luminance of the output light along a direction substantially parallel to the Z1 direction is small, thus the viewing angle of the conventional display apparatus 1 is relatively small and limited in a specific angle range.

Therefore, it is necessary to provide a light guide plate and a transparent display apparatus having the same to solve the above problems.

### SUMMARY

An aspect of the present disclosure relates to a light guide plate. In one embodiment, the light guide plate comprises a transparent light guide plate body and a plurality of microstructures. The transparent light guide plate body has a first surface and a second surface opposite to the first surface, wherein the first surface has a surface roughness of less than or equal to 100 nm. The microstructures are disposed on the first surface. A light beam from the transparent light guide plate body is reflected by the microstructures, and another light beam from the transparent light guide plate body passes through the first surface between the microstructures.

Another aspect of the present disclosure relates to a transparent display apparatus. In one embodiment, the transparent display apparatus comprises a light guide plate, a panel and a light source. The light guide plate comprises a transparent light guide plate body and a plurality of microstructures. The transparent light guide plate body has a first surface and a second surface opposite to the first surface, wherein the first surface has a surface roughness of less than or equal to 100 nm. The microstructures are disposed on the first surface, wherein a light beam from the transparent light guide plate body is reflected by the microstructures, and another light beam from the transparent light guide plate body passes through the first surface between the microstructures. The panel is disposed above the light guide plate, wherein the light beam from the light guide plate enters the panel. The light source is disposed adjacent to the transparent light guide plate body.

Another aspect of the present disclosure relates to a transparent display apparatus. In one embodiment, the transparent display apparatus comprises a light guide plate, a panel and a light source. The light guide plate comprises a transparent light guide plate body and a plurality of microstructures. The transparent light guide plate body has a first surface and a second surface opposite to the first surface. The microstructures are disposed on the first surface. At least one of the microstructures includes a plurality of diffusion particles therein, and the diameter of each of the diffusion particles is less than or equal to 100 nm. A ratio of the height of each of the microstructures to the diameter of each of the microstructures is less than or equal to 0.01. A light beam from the transparent light guide plate body is scattered by the diffusion particles in the at least one of the microstructures, and another light beam from the transparent light guide plate body is reflected by the first surface between the microstructures. The panel is disposed above the light guide plate, wherein the light beam from the light guide plate enters the panel. The light source is disposed adjacent to the transparent light guide plate body.

### BRIEF DESCRIPTION OF THE DRAWINGS

FIG. 1 shows a schematic cross-sectional view of a conventional display apparatus.

FIG. 2 shows a schematic perspective view of the light guide plate of FIG. 1.

FIG. 3 shows a cross-sectional view of a display apparatus according to an embodiment of the present disclosure.

FIG. 4 shows a perspective view of the light guide plate illustrated in FIG. 3.

FIG. 5 shows a partial enlarged view of the light guide plate illustrated in FIG. 3.

FIG. 6 shows a partial enlarged view of the light guide plate according to another embodiment of the present disclosure.

FIG. 7 shows a cross-sectional view of a display apparatus according to another embodiment of the present disclosure.

FIG. 8 shows a cross-sectional view of a display apparatus according to another embodiment of the present disclosure.

FIG. 9 shows a partial enlarged view of the light guide plate illustrated in FIG. 8.

FIG. 10 shows a cross-sectional view of a display apparatus according to another embodiment of the present disclosure.

FIG. 11 shows a partial enlarged view of the display apparatus illustrated in FIG. 10.

FIG. 12 shows a top view of the light guide plate illustrated in FIG. 10.

Common reference numerals are used throughout the drawings and the detailed description to indicate the same or similar elements. Embodiments of the present disclosure will be more apparent from the following detailed description taken in conjunction with the accompanying drawings.

### DETAILED DESCRIPTION

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are specified with respect to a certain component or group of components, or a certain plane of a component or group of components, for the orientation of the component(s) as shown in the associated figure. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

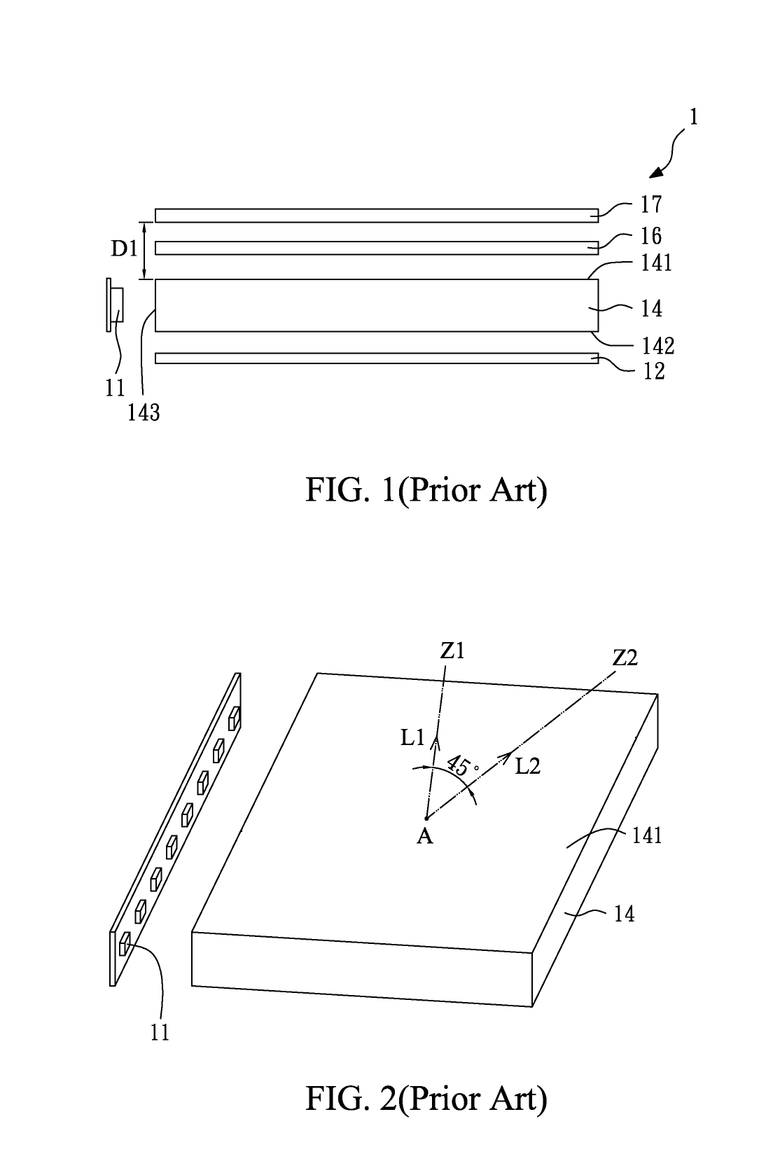

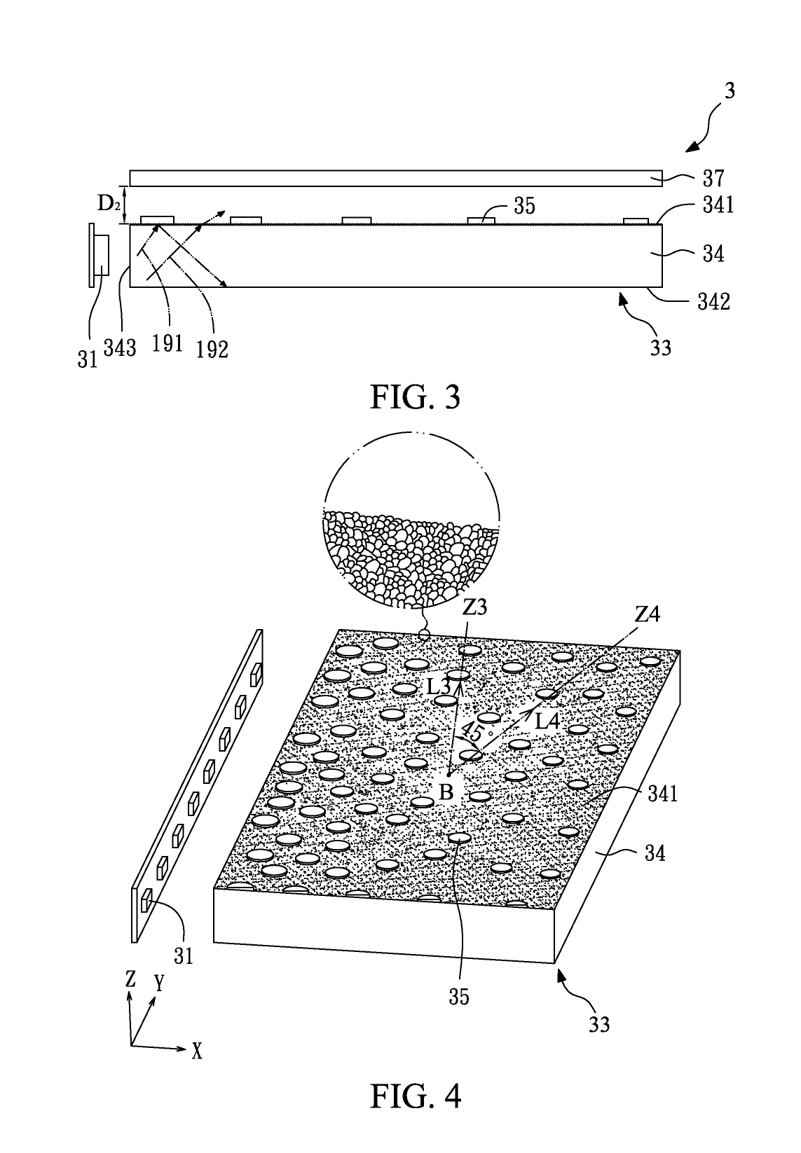

FIG. 3 shows a cross-sectional view of a display apparatus 3 according to an embodiment of the present disclosure. In this embodiment, the display apparatus 3 is a transparent display apparatus, wherein the conventional reflector 12 and the conventional optical films 16 as illustrated in FIG. 1 are omitted. The display apparatus 3 comprises a light source 31, a light guide plate 33 and a panel 37. The light guide plate 33 is used to receive and mix the light beam from the light source 31, and comprises a transparent light guide plate body 34 and a plurality of microstructures 35. The material of the transparent light guide plate body 34 may be polymethyl methacrylate (PMMA), acrylic-based polymer, polycarbonate (PC), polyethylene terephthalate (PET), polystyrene (PS) or glass. In this embodiment, the material of the transparent light guide plate body 34 is glass. The refractive index of the transparent light guide plate body 34 is about 1.5.

The transparent light guide plate body 34 has a first surface 341, a second surface 342 and a side surface 343. The first surface 341 is opposite to the second surface 342, and the side surface 343 extends between the first surface 341 and the second surface 342. In this embodiment, the first surface 341 is the top surface (light-emitting surface), the second surface 342 is the bottom surface, and the side surface 343 is the light incident surface. The first surface 341 has a surface roughness (Ra) of less than or equal to 100 nm. The surface roughness (Ra) of the first surface 341 may be formed by etching, laser engraving, impressing, or injection forming. In this embodiment, the surface roughness (Ra) of the first surface 341 is greater than or equal to 20 nm. The second surface 342 is a flat surface, that is, the surface roughness (Ra) of the second surface 342 is less than that of the first surface 341. In this embodiment, the surface roughness (Ra) of the second surface 342 is less than or equal to 3 nm. However, it is understood that the second surface 342 may be a rough surface with a surface roughness (Ra) of less than or equal to 100 nm.

The microstructures 35 are disposed on the first surface 341 of the transparent light guide plate body 34. The material of the microstructures 35 includes a base resin which includes epoxy resin, polyester resin, acrylic resin, polyvinyl resin, polyamide resin or polyurethane resin. The refractive index of the microstructures 35 is greater than that of air. In this embodiment, the microstructures 35 are transparent ink dots, which are formed by screen printing or ink jet printing. The microstructures 35 are used to reflect and diffuse most of the light beam back to the interior of the transparent light guide plate body 34.

The light source 31, for example, a light bar with a plurality of light emitting diodes (LEDs) or a CCFL, is disposed adjacent to the side surface 343 of the transparent light guide plate body 34, and is used to provide a light beam. Thus, the light beam enters the transparent light guide plate body 34 through the side surface 343 and then is transmitted to the panel 37 through the first surface 341. In this embodiment, the light source 31 is a light bar with a plurality of LEDs. In other embodiment, not shown in the figures, the light source 31 may include a plurality of LEDs, and the transparent light guide plate body 34 may include at least one cavity on the second surface 342 near the side surface 343. Each of the LEDs is disposed in the cavity. Thus, a light beam from the light source 31 enters the transparent light guide plate body 34 through the sidewall of the cavity. In the present disclosure, the location, which the light source 31 is disposed on, is not limited by the embodiments as stated above. The light source 31 is only needed to be disposed adjacent to the transparent light guide plate body 34.

In this embodiment, as shown in FIG. 3, the panel 37 is disposed above/adjacent to the light guide plate 33, and is used to show an image. That is, the panel 37 faces the first surface 341 of the transparent light guide plate body 34. In this embodiment, the light beam from the light guide plate 33 enters the panel 37 directly without passing through any conventional optical films 16 (FIG. 1). The distance D2 between the panel 37 and the light guide plate 33 is less than or equal to 10 mm. Preferably, the distance D2 is zero, that is, the panel 37 contacts the light guide plate 33. In contrast, in a conventional display apparatus with a light guide plate made of PMMA and a panel, for reducing sparkle effect, a distance between the light plate and the panel should be greater than or equal to 10 mm, and for reducing Moire effect, the distance should be greater than or equal to 50 mm.

As shown in FIG. 3, a light beam 191 from the transparent light guide plate body 34 is reflected by the microstructure 35, and another light beam 192 from the transparent light guide plate body 34 passes through the first surface 341 between the microstructures 35. In this embodiment, most of the light beam 191 (more than 50% of the light beam 191) from the transparent light guide plate body 34 is reflected by the microstructure 35, and other portion of the light beam 191 (less than 50% of the light beam 191) from the transparent light guide plate body 34 passes through the microstructure 35. Most of the light beam 192 (more than 50% of the light beam 192) from the transparent light guide plate body 34 passes through the first surface 341 between the microstructures 35, and other portion of the light beam 192 (less than 50% of the light beam 192) from the transparent light guide plate body 34 is reflected by the first surface 341.

FIG. 4 shows a perspective view of the light guide plate 33 illustrated in FIG. 3. In this embodiment, the distribution density is defined as the amount of the microstructures 35 disposed on an unit area of the first surface 341 of the transparent light guide plate body 34. The distribution density of the microstructures 35 near the light source 31 is greater than that of the microstructures 35 away the light source 31. That is, the pitch between the microstructures 35 near the light source 31 is less than that of the microstructures 35 away the light source 31. In addition, the size of the microstructures 35 near the light source 31 is greater than that of the microstructures 35 away the light source 31. In this embodiment, as shown in FIG. 4, the x-coordinate is defined as the direction from left to the right of the figure along the first surface 341 of the transparent light guide plate body 34. The y-coordinate is defined as the direction perpendicular to the x-coordinate along the first surface 341 of the transparent light guide plate body 34. That is, the x-y plane is parallel to the first surface 341 of the transparent light guide plate body 34. The z-coordinate is defined as the direction perpendicular to the x-y plane.

As shown in FIG. 4, the point B may be at any position on the first surface 341 of the transparent light guide plate body 34. The luminance of a third output light L3 from the point B along a Z3 direction is defined as I₃, wherein the Z3 direction is perpendicular to the first surface 341 of the transparent light guide plate body 34. The luminance of a fourth output light L4 from the point B along a Z4 direction is defined as I₄, wherein the inclination angle between the Z3 direction and the Z4 direction is 45 degrees. The ratio of I₃ to IL₄ is greater than or equal to 1. In addition, in this embodiment, the luminance of the different output lights from the same point along different directions is substantially the same. For example, an output light is defined as the light from the point B along any direction, and the inclination angle between the Z3 direction and the direction of the output light is from 0 degree to ±90 degrees. The luminance of the third output light L3 and the luminance of the output light are substantially the same. As a result, the viewing angle of the display apparatus 3 is relatively larger than the conventional display apparatus 1 and not limited in a specific angle range.

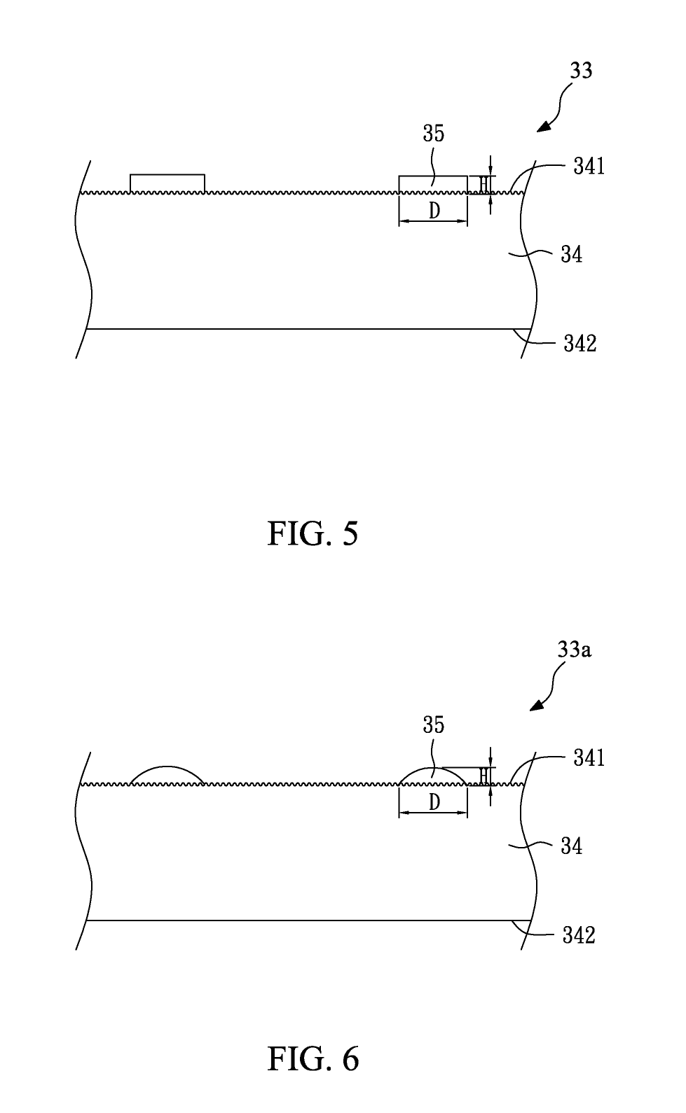

FIG. 5 shows a partial enlarged view of the light guide plate 33 illustrated in FIG. 3. The diameter D of each of the microstructures 35 is less than or equal to 150 so that the dot mura defect is reduced. More specifically, the user cannot substantially distinguish the microstructures 35 when the distance between him and the microstructures 35 is greater than or equal to 30 cm. In addition, the ratio of the height H of each of the microstructures 35 to the diameter D of each of the microstructures 35 is less than or equal to 0.01, preferably, less than or equal to 0.005. In this embodiment, the cross section of the microstructures 35 is substantially rectangular. That is, the configuration of the microstructures 35 is substantially a cylinder.

In this embodiment, because the display apparatus 3 only includes the light guide plate 33 and the panel 37, and the light guide plate 33 and the panel 37 are transparent, the display apparatus 3 is transparent when the light source 31 is turned off. Thus, if the display apparatus 3 is applied to a portion of the front door of a display cabinet, the users can see the articles in the display cabinet through the display apparatus 3 without opening the front door of the display cabinet. Further, the distance D2 between the panel 37 and the light guide plate 33 is relatively small (less than 10 mm), thus, the total thickness of the display apparatus 3 can be reduced efficiently.

FIG. 6 shows a partial enlarged view of the light guide plate 33a according to another embodiment of the present disclosure. The light guide plate 33a of this embodiment is similar to the light guide plate 33 illustrated in FIG. 5, except that the cross section of the microstructures 35 is substantially a semicircle. The top surfaces of the microstructures 35 are curved surfaces. That is, the configuration of the microstructures 35 is substantially a hemisphere, whose appearance is like a lens.

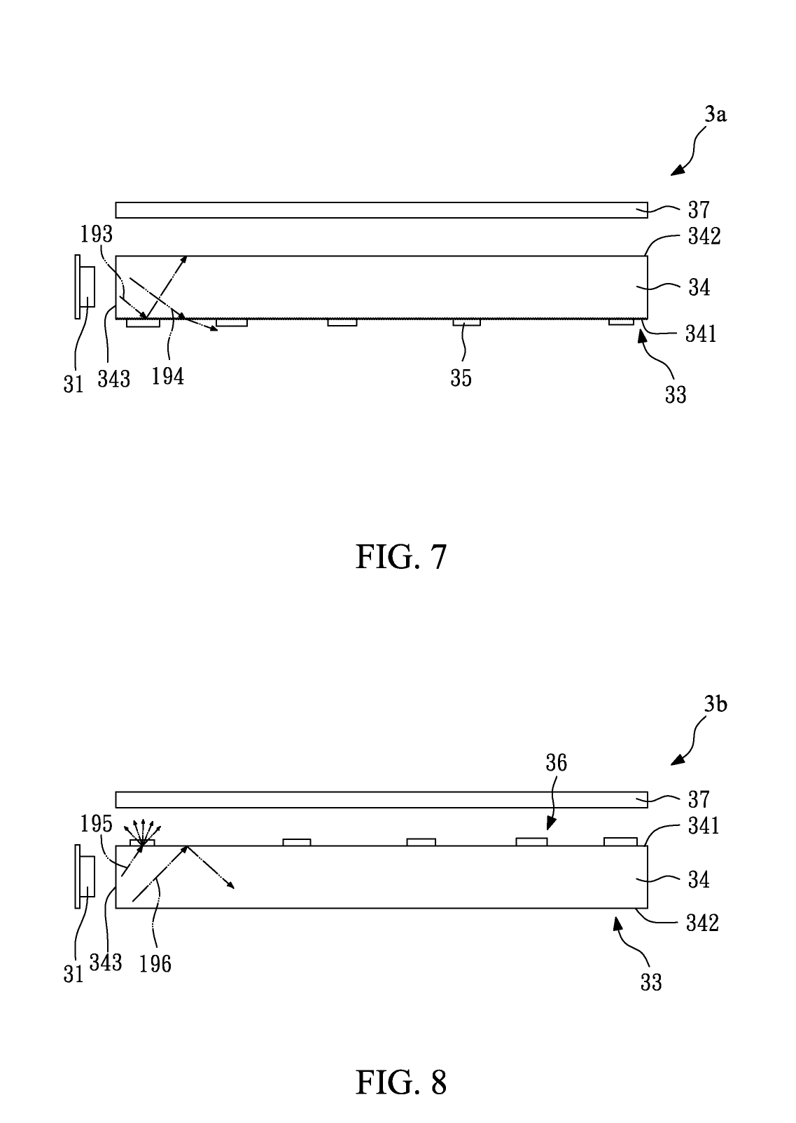

FIG. 7 shows a cross-sectional view of a display apparatus 3a according to another embodiment of the present disclosure. The display apparatus 3a of this embodiment is similar to the display apparatus 3 illustrated in FIG. 3, except that the first surface 341 is the bottom surface, and the second surface 342 is the top surface (light-emitting surface). Thus, the panel 37 faces the second surface 342 of the transparent light guide plate body 34. Similarly, the microstructures 35 are disposed on the first surface 341. A light beam 193 from the transparent light guide plate body 34 is reflected by the microstructure 35, and another light beam 194 from the transparent light guide plate body 34 passes through the first surface 341 between the microstructures 35. In this embodiment, most of the light beam 193 (more than 50% of the light beam 193) from the transparent light guide plate body 34 is reflected by the microstructure 35, and other portion of the light beam 193 (less than 50% of the light beam 193) from the transparent light guide plate body 34 passes through the microstructure 35. Most of the light beam 194 (more than 50% of the light beam 194) from the transparent light guide plate body 34 passes through the first surface 341 between the microstructures 35, and other portion of the light beam 194 (less than 50% of the light beam 194) from the transparent light guide plate body 34 is reflected by the first surface 341. Moreover, all variations with regard to FIG. 3 to FIG. 6 also may be applied in the display apparatus 3a of this embodiment.

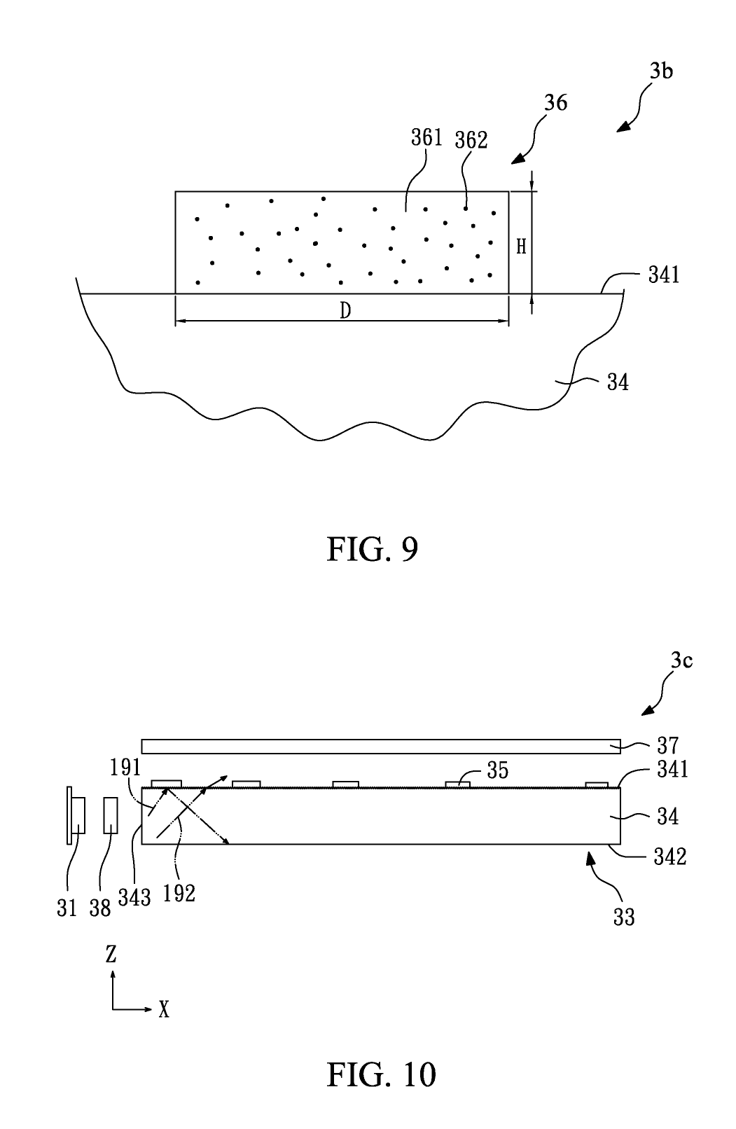

FIG. 8 shows a cross-sectional view of a display apparatus 3b according to another embodiment of the present disclosure. The display apparatus 3b of this embodiment is similar to the display apparatus 3 illustrated in FIG. 3, except that the first surface 341 of the transparent light guide plate body 34 is a flat surface with a surface roughness (Ra) of less than or equal to 3 nm, and the structure and the distribution of the microstructures 36. Each of the microstructures 36 includes a plurality of diffusion particles 362 (FIG. 9) therein. A light beam 195 from the transparent light guide plate body 34 is scattered by the diffusion particles 362 in each of the microstructures 36 and then emits out to the panel 37, and another light beam 196 from the transparent light guide plate body 34 is reflected by the first surface 341 between the microstructures 36 to the interior of the transparent light guide plate body 34. In this embodiment, most of the light beam 195 (more than 50% of the light beam 195) from the transparent light guide plate body 34 is scattered by the diffusion particles 362 in each of the microstructures 36 and then emits out to the panel 37, and other portion of the light beam 195 (less than 50% of the light beam 195) from the transparent light guide plate body 34 is not scattered by the diffusion particles 362 and does not emit out to the panel 37. The other portion of the light beam 195 (less than 50% of the light beam 195) from the transparent light guide plate body 34 may still propagate in the transparent light guide plate body 34. Most of the light beam 196 (more than 50% of the light beam 196) from the transparent light guide plate body 34 is reflected by the first surface 341 between the microstructures 36 to the interior of the transparent light guide plate body 34, and other portion of the light beam 196 (less than 50% of the light beam 196) from the transparent light guide plate body 34 passes through the first surface 341 between the microstructures 36. Moreover, it should be understood that in other embodiment, only a portion of the microstructures 36 include a plurality of diffusion particles 362, and others of the microstructures 36 do not include diffusion particles 362.

In this embodiment, the distribution density of the microstructures 36 near the light source 31 is less than that of the microstructures 36 away the light source 31. That is, the pitch between the microstructures 36 near the light source 31 is greater than that of the microstructures 36 away the light source 31. In addition, the size of the microstructures 36 near the light source 31 is less than that of the microstructures 36 away the light source 31.

FIG. 9 shows a partial enlarged view of the light guide plate 33 illustrated in FIG. 8. The microstructures 36 are disposed on the flat first surface 341 of the transparent light guide plate body 34. Each of the microstructures 36 includes a base resin 361 and at least one of the microstructures 36 includes a plurality of diffusion particles 362. The material of the base resin 361 includes epoxy resin, polyester resin, acrylic resin, polyvinyl resin, polyamide resin or polyurethane resin. The refractive index of the base resin 361 is greater than that of air. In this embodiment, the microstructures 36 are transparent ink dots, which are formed by screen printing or ink jet printing. In this embodiment, the diameter of each of the diffusion particles 362 is less than or equal to 100 nm. Moreover, in some embodiment, the diameter of each of the diffusion particles 362 is greater than or equal to 20 nm. The material of the diffusion particles 362 is silica, epoxy, polyester (PES), polymethyl methacrylate (PMMA), acrylic-based polymer, polyvinyl, polyamide (PA), polyurethane (PU), polystyrene (PS), or a combination thereof.

In some other embodiment, the features of a surface roughness (Ra) of less than or equal to 100 nm, the structure and the distribution of the microstructures 35, and all variations with regard to FIG.3 to FIG. 6 also may be applied in the display apparatus 3b as shown in FIG. 8 and FIG. 9. For example, the second surface 342 of the transparent light guide plate body 34 as shown in FIG. 8 has a surface roughness (Ra) of less than or equal to 100 nm, and the microstructures 35 as shown in FIG.3 are disposed on the second surface 342 of the transparent light guide plate body 34.

FIG. 10 shows a cross-sectional view of a display apparatus 3c according to another embodiment of the present disclosure. The display apparatus 3c of this embodiment is similar to the display apparatus 3 illustrated in FIG. 3, except that the display apparatus 3c of this embodiment further comprises at least one collimating element 38, and the light emitting diodes (LEDs) of the light source 31 are individually controlled to emit light. That is, each of the light emitting diodes (LEDs) may be turned on or turned off individually. The collimating element 38 is disposed between the transparent light guide plate body 34 and one of the LEDs. In this embodiment, one collimating element 38 corresponds to one LED; however, in some embodiment, one collimating element 38 may correspond to two or more LEDs. The collimating element 38 is used to collimate the light beam from the light source 31. Thus, the light beam after passing the collimating element 38 forms a substantially one-dimensional collimating light.

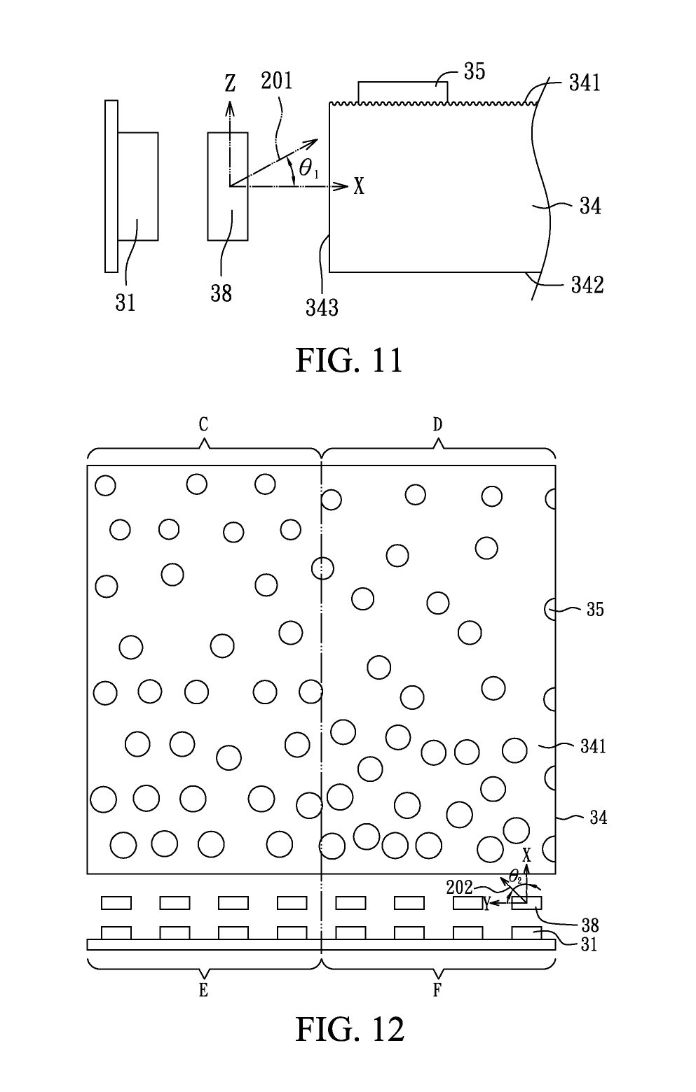

FIG. 11 shows a partial enlarged view of the display apparatus 3c illustrated in FIG. 10. The angle between an emitting direction of the first collimating light 201 and the x-coordinate on the x-z plane (vertical plane) is defined as the vertical viewing angle θ1. The x-coordinate is defines as the normal direction of the collimating element 38. The vertical viewing angle θ1 is zero when the first collimating light 201 is along the x-coordinate. The vertical viewing angle θ1 is positive when the first collimating light 201 is above the x-coordinate, and the vertical viewing angle θ1 is negative when the first collimating light 201 is below the x-coordinate. In addition, referring to FIG. 12, the angle between an emitting direction of the second collimating light 202 and the x-coordinate on the x-y plane (horizontal plane) is defined as the horizontal viewing angle θ2. The x-y plane (horizontal plane) is parallel to the first surface 341 of the transparent light guide plate body 34, and is perpendicular to the x-z plane (vertical plane). The horizontal viewing angle θ2 is zero when the second collimating light 202 is along the x-coordinate. The horizontal viewing angle θ2 is positive when the second collimating light 202 is on the left side of the x-coordinate, and the horizontal viewing angle θ2 is negative when the second collimating light 202 is on the right side of the x-coordinate.

Theoretically, the degree of collimation of the light is defined as the distributions of light in these two angles (the vertical viewing angle θ1 and the horizontal viewing angle θ2), and is characterized by the angle between the 50% peak flux points, i.e., the full width half maximum (FWHM). In this embodiment, on the x-z plane (vertical plane) (FIG. 11), FWHM of vertical viewing angle θ1 is ±30 degrees. Thus, the flux of the first collimating light 201 with θ1 from −30 degrees to 30 degrees is greater than ten times the sum of the flux of the first collimating light 201 with θ1 from 30 degrees to 90 degrees and the flux of the first collimating light 201 with θ1 from −90 degrees to −30 degrees. Therefore, more than 90 percentages of the total flux of the first collimating light 201 on the x-z plane (vertical plane) is disposed within θ1 of ±30 degrees. In addition, on the x-y plane (horizontal plane) (FIG. 12), FWHM of horizontal viewing angle θ2 is ±30 degrees. Thus, the flux of the second collimating light 202 with θ2 from −30 degrees to 30 degree is greater than ten times the sum of the flux of the second collimating light 202 with θ2 from 30 degrees to 90 degrees and the flux of the second collimating light 202 with θ2 from −90 degrees to −30 degrees. Therefore, more than 90 percentages of the total flux of the second collimating light 202 on the x-y plane (horizontal plane) is disposed within θ2 of ±30 degrees.

FIG. 12 shows a top view of the light guide plate 33 illustrated in FIG. 10. In this embodiment, the light source 31 can be divided into two portions: portion E and portion F. The transparent light guide plate body 34 can be divided into two portions: portion C and portion D, wherein the portion C of the transparent light guide plate body 34 corresponds to the portion E of the light source 31, and the portion D of the transparent light guide plate body 34 corresponds to the portion F of the light source 31. As stated above, the light emitting diodes (LEDs) of the light source 31 are individually controlled to emit light and the collimating element 38 has the function of collimating the light beam from the light source 31, the light emitting diodes (LEDs) disposed in portion E may be turned on, and the light emitting diodes (LEDs) disposed in portion F may be turned off. Meanwhile, the light beam from the light emitting diodes (LEDs) in portion E will enter the portion C of the transparent light guide plate body 34, and will not substantially enter the portion D of the transparent light guide plate body 34. Therefore, only the image of the panel 37 corresponding to the portion C of the transparent light guide plate body 34 will be shown, and the portion of the panel 37 corresponding to the portion D of the transparent light guide plate body 34 is still in transparent state. Thus, if the display apparatus 3c (FIG. 10) is applied to a portion of the front door of a display cabinet, the users can see the articles in the display cabinet through the portion of the panel 37 corresponding to the portion D of the transparent light guide plate body 34 without opening the front door of the display cabinet, and meanwhile, the users can see the information provided by the portion of the panel 37 corresponding to the portion C of the transparent light guide plate body 34.

While several embodiments of the present disclosure have been illustrated and described, various modifications and improvements can be made by those skilled in the art. The embodiments of the present disclosure are therefore described in an illustrative but not restrictive sense. It is intended that the present disclosure should not be limited to the particular forms as illustrated, and that all modifications which maintain the spirit and scope of the present disclosure are within the scope defined in the appended claims.

What is claimed is:

1. A light guide plate, comprising:
a transparent light guide plate body, having a first surface and a second surface opposite to the first surface, wherein the first surface has a surface roughness of less than or equal to 100 nm; and
a plurality of microstructures, disposed on the first surface;
wherein a light beam from the transparent light guide plate body is reflected by the microstructures, and another light beam from the transparent light guide plate body passes through the first surface between the microstructures.

2. The light guide plate as claimed in claim 1, wherein the surface roughness is greater than or equal to 20 nm.

3. The light guide plate as claimed in claim 1, wherein the diameter of each of the microstructures is less than or equal to 150 μm.

4. The light guide plate as claimed in claim 1, wherein a ratio of the height of each of the microstructures to the diameter of each of the microstructures is less than or equal to 0.01.

5. The light guide plate as claimed in claim 1, wherein a ratio of the height of each of the microstructures to the diameter of each of the microstructures is less than or equal to 0.005.

6. A transparent display apparatus, comprising:
a light guide plate, comprising:
a transparent light guide plate body, having a first surface, and a second surface opposite to the first surface, wherein the first surface has a surface roughness of less than or equal to 100 nm; and
a plurality of microstructures, disposed on the first surface, wherein a light beam from the transparent light guide plate body is reflected by the microstructures, and another light beam from the transparent light guide plate body passes through the first surface between the microstructures;
a panel, disposed above the light guide plate, wherein the light beam from the light guide plate enters the panel; and
a light source, disposed adjacent to the transparent light guide plate body.

7. The transparent display apparatus as claimed in claim 6, wherein a distance between the panel and the light guide plate is less than or equal to 10 mm.

8. The transparent display apparatus as claimed in claim 6, wherein the surface roughness is greater than or equal to 20 nm.

9. The transparent display apparatus as claimed in claim 6, wherein the diameter of each of the microstructures is less than or equal to 150 μm.

10. The transparent display apparatus as claimed in claim 6, wherein a ratio of the height of each of the microstructures to the diameter of each of the microstructures is less than or equal to 0.01.

11. The transparent display apparatus as claimed in claim 6, wherein a ratio of the height of each of the microstructures to the diameter of each of the microstructures is less than or equal to 0.005.

12. The transparent display apparatus as claimed in claim 6, further comprising at least one collimating element, wherein the light source includes a plurality of light emitting diodes (LEDs) that are individually controlled to emit light, and the collimating element is disposed between the transparent light guide plate body and one of the LEDs.

13. The transparent display apparatus as claimed in claim 12, wherein a light beam after passing the collimating element is defined as a collimating light, more than 90 percentages of the total flux of a first collimating light on a vertical plane is disposed within a vertical viewing angle θ1 of ±30 degrees, and more than 90 percentages of the total flux of a second collimating light on a horizontal plane is disposed within a horizontal viewing angle θ2 of ±30 degrees, wherein the horizontal plane is parallel to the first surface of the transparent light guide plate body and is perpendicular to the vertical plane, the vertical viewing angle θ1 is defined as the angle between an emitting direction of the first collimating light and the normal direction of the collimating element, and the horizontal viewing angle θ2 is defined as the angle between an emitting direction of the second collimating light and the normal direction of the collimating element.

14. A transparent display apparatus, comprising:
a light guide plate, comprising:
a transparent light guide plate body, having a first surface and a second surface opposite to the first surface; and
a plurality of microstructures, disposed on the first surface, wherein at least one of the microstructures includes a plurality of diffusion particles therein, and the diameter of each of the diffusion particles is less than or equal to 100 nm, and a ratio of the height of each of the microstructures to the diameter of each of the microstructures is less than or equal to 0.01, wherein a light beam from the transparent light guide plate body is scattered by the diffusion particles in the at least one of the microstructures, and another light beam from the transparent light guide plate body is reflected by the first surface between the microstructures;
a panel, disposed above the light guide plate, wherein the light beam from the light guide plate enters the panel; and
a light source, disposed adjacent to the transparent light guide plate body.

15. The transparent display apparatus as claimed in claim 14, wherein a distance between the panel and the light guide plate is less than or equal to 10 mm.

16. The transparent display apparatus as claimed in claim 14, wherein the diameter of each of the microstructures is less than or equal to 150 μm.

17. The transparent display apparatus as claimed in claim 14, wherein a ratio of the height of each of the microstructures to the diameter of each of the microstructures is less than or equal to 0.005.

18. The transparent display apparatus as claimed in claim 14, further comprising at least one collimating element, wherein the light source includes a plurality of light emitting diodes (LEDs) that are individually controlled to emit light, and the collimating element is disposed between the transparent light guide plate body and one of the LEDs.

19. The transparent display apparatus as claimed in claim 18, wherein a light beam after passing the collimating element is defined as a collimating light, more than 90 percentages of the total flux of a first collimating light on a vertical plane is disposed within a vertical viewing angle θ1 of ±30 degrees, and more than 90 percentages of the total flux of a second collimating light on a horizontal plane is disposed within a horizontal viewing angle θ2 of ±30 degrees, wherein the horizontal plane is parallel to the first surface of the transparent light guide plate body and is perpendicular to the vertical plane, the vertical viewing angle θ1 is defined as the angle between an emitting direction of the first collimating light and the normal direction of the collimating element, and the horizontal viewing angle θ2 is defined as the angle between an emitting direction of the second collimating light and the normal direction of the collimating element.
